(19) United States
(12) Patent Application Publication
(10) Pub. No.: US 2008/0000664 A1
(43) Pub. Date: Jan. 3, 2008

(54) Hand-Held Power Tool Handle Device With a Vibration-Shielding Unit

(76) Inventor: Hubert Steinke, Leinfelden-Echterdingen (DE)

Correspondence Address: Striker Striker & Stenby, 103 East Neck Road, Huntington, NY, 11743, US

(21) Appl. No.: 10/564,145

(22) PCT Filed: May 3, 2005
(86) PCT No.: PCT/EP05/52020

§ 371 Date: Jan. 10, 2006

(30) Foreign Application Priority Data
Aug. 26, 2004 (DE) 10 2004 041 219.7

(51) Int. Cl. B25D 17/04

(52) U.S. Cl. 173/162.2

(57) ABSTRACT

The present invention is directed to a hand-held power tool handle device with a vibration-shielding unit (10) and a guide device (12) for guiding a motion (26) of a handle element (16) which is movably supported relative to a hand-held power tool body (14).

It is provided that the motion (26) is at least substantially along a straight line.

### BACKGROUND INFORMATION

The present invention is directed to a hand-held power tool handle device with a vibration-shielding unit according to the definition of the species in claim 1, and a hand-held power tool according to the definition of the species in claim 12.

It has already been provided to equip a hand-held power tool with a hand-held power tool handle device that includes a vibration-shielding unit. Generic hand-held power tool handle devices typically include a handle element supported such that it is pivotable around a pivot axis, or a handle element provided with at least two degrees of freedom of motion.

### ADVANTAGES OF THE INVENTION

The present invention is directed to a hand-held power tool handle device with a vibration-shielding unit and a guide device for guiding a motion of a handle element which is movably supported relative to a hand-held power tool body.

It is provided that the motion is at least substantially along a straight line. As a result, impact impulses of a hand-held power tool that includes the hand-held power tool handle device can be shielded via a straight-line motion, preferably in the direction of the impact impulse, independently of a direction in which an operator exerts a supporting force on the operating element. A direct transfer of the impact impulse or a component thereof via a joint or a pivotable support can be prevented. Furthermore, a tilting and resultant turning of the handle element can be prevented without having to relinquish any of the ruggedness of operation required on the job site.

In this context, “motion along a straight line” is understood to mean purely translatory motion in the form of parallel displacement. The vibration-shielding unit can be designed as a resilient vibration-shielding unit that reflects the individual impulses of a vibration back into the hand-held power tool body and/or transfers them, low-pass filtered, out of the hand-held power tool body to the handle element. Or, the vibration-shielding unit can be designed as a vibration-dampening or vibration-absorbing unit that is suited to dissipating absorbed vibratory energy. Embodiments of the present invention are particularly advantageous in which the vibration-shielding unit dissipates a first portion of the vibration energy and reflects a further portion of the vibration energy.

In an embodiment of the present invention it is provided that the handle element is positioned at a distance away from the hand-held power tool body. As a result, the situation can be prevented in which the motion is blocked by dust particles and/or chips that can become stuck between the handle element and the hand-held power tool body. Contamination, which can occur in particular during operation on a job site, can be easily removed. A frame, which is required due to the distance, can be protected using covering means that are elastic and/or supported such that they are displaceable in the direction of motion, to prevent contamination.

It is furthermore provided that the hand-held power tool handle device include at least two force-transmission elements which cross over each other. As a result, transversal forces exerted on the handle element can be supported in a particularly effective manner.

A particularly reliable guidance of the motion of the handle element can be achieved when the force-transmission elements are interconnected in a pivoting manner by a connecting element and, in fact, by the connecting element located in a central region of the force-transmission elements, so that the force-transmission elements can make a scissors-type motion. Particularly advantageously, the connecting element can be integrally moulded on at least one of the force-transmission elements.

By way of at least one elastic return element for returning the handle element, a permanently-defined starting position can be achieved, from which a particularly effective vibration shielding can be achieved.

Vibration shielding that is particularly comfortable can be achieved when the hand-held power tool handle device includes at least one elastically deformable impact-absorption element. The potential to reduce costs can be realized when the return element and the impact-absorption element are configured as a single component. Various elastomers that appear reasonable to one skilled in the art, e.g., elastomers with a microcellular rubber structure, can be used as the impact-absorption elements.

Impairment of the guidance properties of the hand-held power tool handle device by the return element can be prevented when the return element engages with at least one force-transmission element, and, particularly advantageously, with at least two force-transmission elements. As a result, it can be attained that a force of the return element is enhanced or reduced via lever action and can be advantageously adapted to customer needs by selecting a force-application point.

Further operator comfort is attainable when the handle element includes an impact-absorbing and/or non-slip rubber coating on a side facing an operator, it being advantageously possible for the rubber coating to also have hand perspiration-absorbing properties.

If the handle element is shaped like the letter “D”, particularly advantageous handling of the hand-held power tool can be attained. In particular, an On/Off switch of the hand-held power tool can be protected against uncontrolled applications of force, e.g., impacts.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 Shows a rotary hammer with a hand-held power tool handle device that includes a vibration-shielding unit,

FIG. 2 Shows a hand-held power tool handle device with a vibration-shielding unit in an alternative embodiment of the present invention, and

FIG. 3 Shows a hand-held power tool handle device with a vibration-shielding unit in a further alternative embodiment of the present invention.

### DETAILED DESCRIPTION OF THE EXEMPLARY EMBODIMENTS

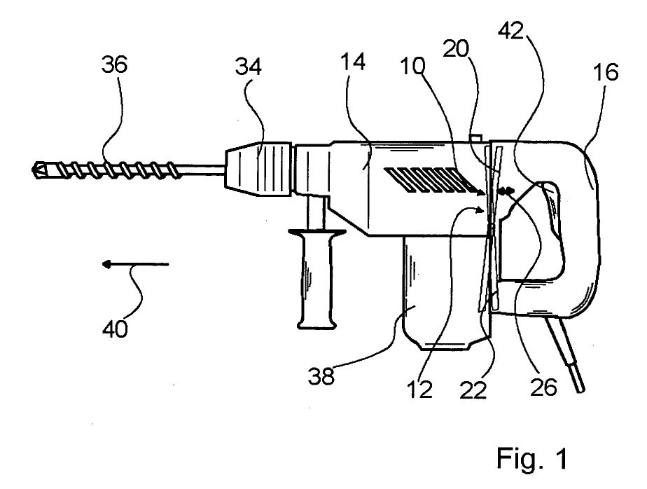

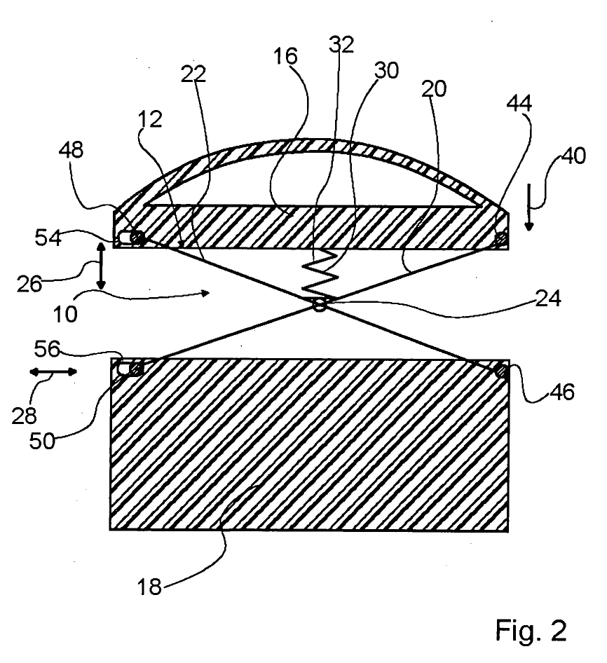

FIG. 1 shows a hand-held power tool designed as a rotary hammer with a hand-held power tool body 14, a tool chuck 34 and a clamped tool 36. A not-shown impact mechanism integrated in hand-held power tool body 14 is driven by a motor 38 and generates axial impact impulses on tool 36 in a working direction 40. On a side facing away from tool 36, hand-held power tool body 14 has a D-shaped handle element 16 with an On/Off switch 42 located on the inside of handle element 16. Handle element 16 is supported on hand-held power tool body 14 such that it is displaceable in working direction 40.

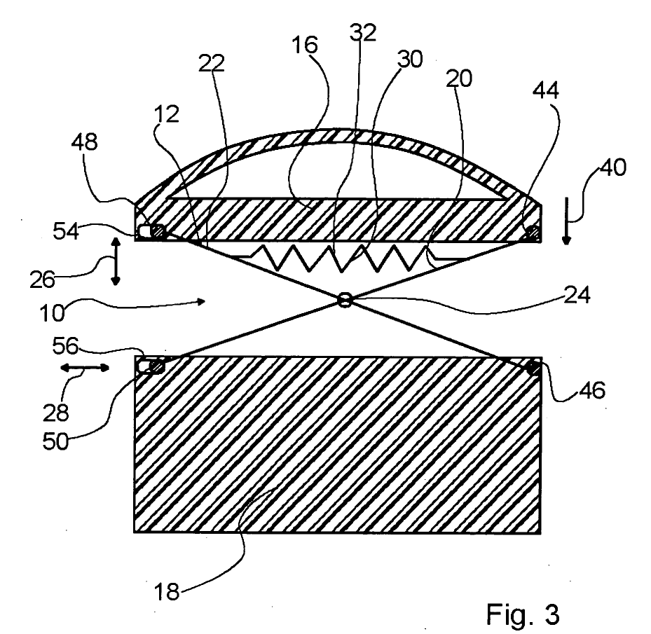

A motion 26 of handle element 16 is guided by a guide device 12 along a straight line in working direction 40, so that an operator can displace handle element 16 against a spring force relative to hand-held power tool body 14 in working direction 40. The spring force is produced by a vibration-shielding unit 10, which includes a return element 30 designed as a coiled spring in addition to guide device 12 (FIG. 2). FIG. 2 shows a schematic depiction of a section through handle element 16 and vibration-shielding unit 10. Handle element 16 is located at a distance of approximately 1-1.5 cm from a housing of hand-held power tool body 14. A gap between handle element 16 and hand-held power tool body 14 is covered by covering means supported such that they are displaceable in the direction of motion 26 and that overlap an edge of hand-held power tool body 14.

Guide device 12 is composed essentially of two force-transmission elements 20, 22 that cross over each other, are designed as blanked/flexural sheet-metal parts and that are interconnected—in a central region by a connecting element 24 designed as a bolt—such that they are pivotable in the manner of a scissors.

Rod-shaped force-transmission elements 20, 22 are pivotably supported via further bolts 44, 46 at an end shown on the right in FIG. 2. First force-transmission element 20 is pivotably supported on a housing 18 of hand-held power tool body 14 and second force-transmission element 22 is pivotably supported on handle element 16.

At an end shown on the left in FIG. 2, first force-transmission element 20 is displaceably supported on handle element 16 via a third bolt 48 that engages in a slot 54 oriented perpendicularly to the motion 26 and/or working direction 40, a direction 28 of displacement corresponding to the direction of slot 54.

Analogously, second force-transmission element 22 is displaceably supported on housing 18 via a fourth bolt 50 that engages in a slot 56 oriented perpendicularly to motion 26 and/or working direction 40.

When an operator moves handle element 16 in working direction 40, bolts 48, 50 are displaced in their respective slots 54, 56 perpendicularly to working direction 40 and/or to motion 26 of handle element 16 until bolts 48, 50 contact an end—shown on the left in FIG. 2—of slots 54, 56. Motion 26 is therefore limited in working direction 40.

Analogously, the right ends of slots 54, 56 limit motion 26 against working direction 40. During motion 26, force-transmission elements 20, 22 pivot around connecting element 24, and the compression spring of vibration-shielding unit 10 located between connecting element 24 and handle element 16 and/or return element 30 is compressed or decompressed. Return element 30 produces the spring force of vibration-shielding unit 10.

In a state free of external forces, return element 30 positions handle element 16 against working direction 40 in a starting position defined by the left ends of slots 54, 56 with the greatest possible distance between handle element 16 and housing 18.

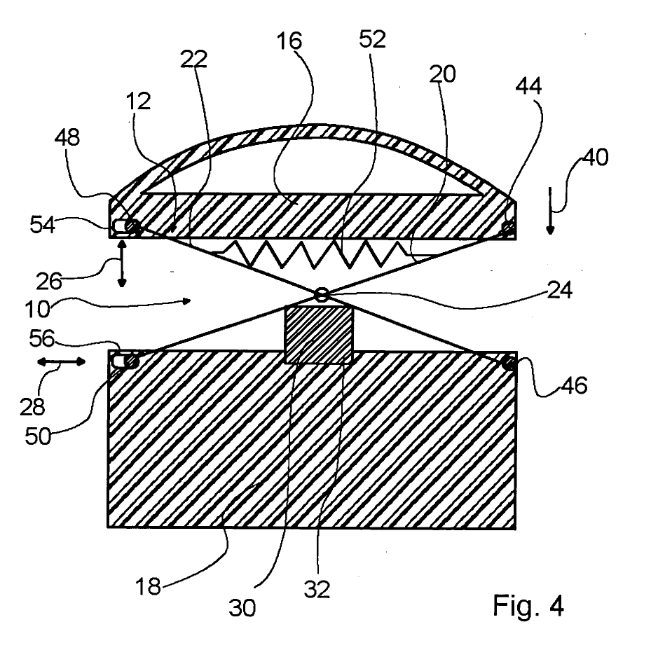

If an impact impulse produced by the impact mechanism is at least partially reflected by a workpiece, the impact impuse can travel through tool 36 and tool chuck 34 into housing 18 of hand-held power tool body 14 which, as a result, accelerates against working direction 40. If an operator exerts a force on handle element 16 that includes at least one component in working direction 40, housing 18 moves—due to the reflected portion of the impact impulse—against the force of the compression spring and/or return element 30 in the direction of handle element 16, which moves relative to housing 18, guided by guide device 12. A force transmitted via return element 30 on handle element 16 increases slowly compared to a course of the impact impulse over time and is supported by the operator, so that the operator can absorb the impact impulse over an extended period of time. As a result, guide device 12 with return element 30 acts as a vibration-shielding unit 10, which filters out high-frequency components of a vibration of hand-held power tool body 14. As a result, return element 30 serves simultaneously as impact-absorption element 32. Embodiments of the present invention are also feasible in which an impact-absorption element 32 is provided that is separate from return element 30. Further exemplary embodiments of the present invention are depicted in FIGS. 3 and 4. Similar features are labelled with the same reference numerals. The description will mainly address the differences from the exemplary embodiment shown in FIGS. 1 and 2. With regard for identical features, reference is made to the description of the exemplary embodiment shown in FIGS. 1 and 2.

FIG. 3 shows an alternative vibration-shielding unit 10, in which return element 30 is designed as a tension spring that engages in each of the two halves of force-transmission elements 20, 22 facing a handle element 16. The tension spring is under preload when handle element 16 is in a starting position.

FIG. 4 shows an exemplary embodiment of the present invention that has the features of the exemplary embodiment shown in FIG. 3 as well as an impact-absorption element 32 designed as a rubber component that simultaneously acts as a return element 30 and is located between a connecting element 24 designed as a bolt and a housing 18 of a rotary hammer that includes the device. The effect of return element 30 can be enhanced by tension spring 52, which is represented by a dashed line.

Embodiments of the present invention are feasible in which a plurality of preferably identically-constructed vibration-shielding units 10 is located along a longitudinal extension of handle element 16. Furthermore, embodiments of the present invention with alternative impact-absorption units that appear reasonable to one skilled in the art, e.g., with an inelastically deformable material or hydraulic shock absorbers, are feasible.

What is claimed is:

1. A hand-held power tool handle device with a vibration-shielding unit (10) and a guide device (12) for guiding a motion (26) of a handle element (16) which is movably supported relative to a hand-held power tool body (14),
wherein
the motion (26) is at least substantially along a straight line.

2. The hand-held power tool as recited in claim 1,
wherein
the handle element (16) is positioned at a distance away from the hand-held power tool body (14).

3. The hand-held power tool handle device as recited in claim 1, characterized by at least two force-transmission elements (20, 22) which cross over each other.

4. The hand-held power tool handle device as recited in claim 3,
wherein
the force-transmission elements (20, 22) are interconnected in a pivoting manner by a connecting element (24).

5. The hand-held power tool handle device as recited in claim 4,
wherein
the connecting element (24) is located in a central region of at least one of the force-transmission elements (20, 22).

6. The hand-held power tool handle device as recited in claim 1,
wherein
at least one force-transmission element (20, 22) is supported on at least one end such that it is displaceable in a direction (28) extending perpendicularly to the direction of motion (26).

7. The hand-held power tool handle device as recited in claim 4,
wherein
each of the force-transmission elements (20, 22) is displaceably supported at one end.

8. The hand-held power tool handle device as recited in claim 1, characterized by at least one return element (30) for returning the handle element (16).

9. The hand-held power tool handle device as recited in claim 1, characterized by at least one elastically deformable impact-absorption element (32).

10. The hand-held power tool handle device as recited in claim 8,
wherein
the return element (30) and the impact-absorption element (32) are configured as a single component.

11. The hand-held power tool handle device as recited in claim 4, wherein
the return element (30) engages with at least one force-transmission element (20, 22).

12. A hand-held power tool with a hand-held power tool handle device as recited in claim 1.
